(19) United States
(12) Patent Application Publication
(10) Pub. No.: US 2007/0106018 A1
(43) Pub. Date: May 10, 2007

(54) Isocyanate-functional prepolymers and coating materials based thereon with improved properties, a process for preparing them and their use

(75) Inventors: Burkhard Kohler, Leverkusen (DE); Thomas Baker, Koln (DE); Malte Homann, Odenthal (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/591,888

(22) Filed: Nov. 2, 2006

(30) Foreign Application Priority Data
Nov. 5, 2005 (DE) 102005052813.9

(51) Int. Cl. B05D 3/02; C08G 18/08

(52) U.S. Cl. 524/589; 427/372.2

(57) ABSTRACT

The present invention relates to the preparation of new isocyanate-functional prepolymers from styrene-allyl alcohol copolymers and MDI, and also to their use as moisture-curing polyurethane coatings for corrosion control.

### CROSS-REFERENCE TO RELATED APPLICATIONS

The present application claims the right of priority under 35 U.S.C. §119 (a)-(d) of German Patent Application Number 10 2005 052 813.9, filed Nov. 25, 2005.

### BACKGROUND OF THE INVENTION

The present invention relates to the preparation of new isocyanate-functional prepolymers from styrene-allyl alcohol copolymers and mehtylenediphenyl diisocyanate (MDI), and also to their use as moisture-curing polyurethane (PU) coatings particularly suitable for corrosion control.

MDI prepolymers based on polypropylene oxides are used for the corrosion-control coating of steel.

The preparation of styrene-allyl alcohol copolymers or their alkoxylation products and their crosslinking with (blocked) isocyanates is well established. They can be prepared in accordance with U.S. Pat. No. 3,969,569 and U.S. Pat. No. 4,144,215. According to the teaching of U.S. Pat. No. 3,969,569, however, coatings of this kind, comprising blocked isocyanates and styrene-allyl alcohol copolymers, have to be baked at high temperatures of more than 225° C., for reasons which include the deblocking of the NCO groups, which is needed for crosslinking. With unblocked isocyanates, moreover, according to U.S. Pat. No. 4,144,215, styrene-allyl alcohol copolymers can be applied only as a two-component system.

It was an object of the present invention, then, to find a coating system which has the desirable properties of the styrene-allyl alcohol copolymer PU coating materials, such as water repellence, but can be applied as a one-component system and is curable at room temperature.

It has now been found that it is possible to prepare prepolymers from styrene-allyl alcohol copolymers with MDI in an equivalent ratio of OH to NCO groups of 1:≧2. The prepolymers can be used to give moisture-curing coating materials having good corrosion-control properties on critical substrates.

### SUMMARY OF THE INVENTION

The invention accordingly provides a process for preparing PU prepolymers comprising reacting one or more OH-functional copolymers of vinylaromatics and allyl alcohol with methylenediphenyl diisocyanate (MDI), the equivalent ratio of OH to NCO groups being 1:≧2.

The OH to NCO equivalent ratio is preferably 1:2 to 1:50, more preferably 1:2 to 1:20.

The invention further provides the prepolymers obtainable in accordance with the invention, and also coating systems based on these prepolymers.

### DETAILED DESCRIPTION OF THE PREFERRED EMBODIMENTS

The prepolymers of the invention are preferably prepared as follows: over a period of 0.5 to 8 h a solution of the copolymer of vinylaromatics and allyl alcohol in 0.3 to 3 times the amount, by weight based on the copolymer, of a non-isocyanate-reactive solvent, is metered into MDI in an equivalent ratio of (OH groups to NCO groups) 1:2 to 1:20.

Copolymers of vinylaromatics and allyl alcohol for the purposes of the invention are, for example, copolymers of allyl alcohol and styrene, 3-methylstyrene, 4-methylstyrene, alpha-methylstyrene, 4-tert-butylstyrene, 4-chlorostyrene, 3-chlorostyrene, 4-bromostyrene, 3-bromostyrene, 2-trifluoromethylstyrene, 3-trifluoromethylstyrene, 4-trifluoromethylstyrene, 4-cyanostyrene, alkyl esters of 4-vinylbenzoic acid and/or mixtures thereof, preferably of allyl alcohol and styrene.

The copolymers of vinylaromatics and allyl alcohol can be prepared by free-radically copolymerizing the vinylaromatics with allyl alcohol.

The copolymers may also be prepared by reducing copolymers of the vinylaromatic and alkyl acrylates or acrylic or maleic acid derivatives, such as maleic anhydride, or fumaric acid derivatives, with metal hydrides, such as lithium alanate, but the free-radical copolymerization with allyl alcohol is the preferred path.

Copolymers of this kind of vinylaromatics and allyl alcohol preferably have an OH content of 2% to 10% by weight, more preferably of 3% to 8.5% by weight, a preferred molar mass (number average) of 800 to 5000 g/mol and a preferred molar mass (weight average) of 1500 to 11 000 g/mol.

The methylenediphenyl diisocyanate (MDI) is typically an isomer mixture with at least 80% by weight of the monomeric diisocyanate isomers 2,2′-, 2,4′- and 4,4′-MDI.

Preference is given to an isomer mixture with at least 90% by weight of the monomeric diisocyanate isomers 2,2′-, 2,4′- and 4,4′-MDI, particular preference to an isomer mixture with at least 95% by weight of the monomeric diisocyanate isomers 2,2′-, 2,4′- and 4,4′-MDI, and very particular preference to an isomer mixture with at least 98% by weight of the monomeric diisocyanate isomers 2,2′-, 2,4′- and 4,4′-MDI.

It is preferred to use isomer mixtures of the aforementioned kind in which the sum of the monomeric diisocyanate isomers comprises at least 90% by weight of 4,4′-MDI and 2,4′-MDI, more preferably at least 95% by weight of 4,4′-MDI and 2,4′-MDI, and with particular preference at least 98% by weight of 4,4′-MDI and 2,4′-MDI.

The isomer mixtures used may contain up to 25% by weight of MDI oligomers (consisting of at least three aromatics joined via methylene bridges, each aromatic bearing one isocyanate group), preferably up to 15% by weight of MDI oligomers, more preferably up to 5% by weight of MDI oligomers, and very preferably up to 2% by weight of MDI oligomers.

Non-isocyanate-reactive solvents for the purposes of the invention are aliphatic, aromatic or araliphatic solvents which do not contain any cerivitinov-active hydrogen atoms but do preferably contain ether groups and/or ester groups and/or halogen atoms and/or nitrile groups and/or amide groups. Examples of suitable solvents include methoxypropyl acetate, methoxyethyl acetate, ethylene glycol diacetate, propylene glycol diacetate, glyme, diglyme, dioxane, tetrahydrofuran, dioxolane, tert-butyl methyl ether, ethyl acetate, chloroform, methylene chloride, chlorobenzene, o-dichlorobenzene, anisole, 1,2-dimethoxybenzene, phenyl acetate, N-methyl-2-pyrrolidone, dimethylformamide, N,N-dimethylacetamide, dimethyl sulphoxide, acetonitrile, phenoxyethyl acetate and/or mixtures thereof, preferably solvents containing ether and ester groups, such as methoxypropyl acetate.

Some or all of any excess MDI can be removed, following prepolymer formation, by vacuum distillation, preferably thin-film distillation.

The invention further provides moisture-curing coating materials comprising the prepolymers of the invention and binders, the prepolymer content being preferably at least 50% by weight, more preferably 60% to 90% by weight, based on the sum of prepolymer and binder.

These moisture-curing coating materials can be applied as one-component systems.

As additional binders, the moisture-curing coating materials may comprise other polyisocyanates or isocyanate-functional prepolymers formed from polyalkylene oxides and polyisocyanates, preferably polypropylene oxides having OH functionalities of 2 to 4 and molar masses (number average) of 400 to 6000 g/mol and aromatic polyisocyanates, such as TDI, TDI trimers, TDI adducts and MDI.

Further possible ingredients of the coating materials include pigments, active rust prevention pigments, corrosion inhibitors, fillers, barrier-effect fillers (plated-shaped phyllosilicates or phylloaluminosilicates, graphite or aluminium flakes) and nanofillers (such as clays and aluminium silicates).

In addition it is possible for catalysts (tin compounds, amines, amidines, guanidines, zinc compounds, cobalt compounds, bismuth compounds, lithium salts, such as lithium molybdate, magnesium salts, calcium salts) and dryers (such as tosyl isocyanate, reactive aromatic isocyanates or orthoformates) for increasing storage stability to be present.

Based on solids, the coating materials contain preferably at least 5% to 100% by weight of non-isocyanate-reactive solvents.

The coating materials are cured typically at a temperature of 0 to 80° C., preferably at a temperature of 10 to 70° C more preferably at a temperature of 15 to 50° C.

The coating materials serve preferably for coating critical steel substrates from which rust has been removed only by means of simple measures (surface pre-treatment ST2 in accordance with ISO 12944-4).

The coating materials of the present invention are distinguished over coatings of the prior art primarily by improved corrosion control, as demonstrated in the following examples.

### EXAMPLES

Measurement Methods:

Viscosity: Rotational viscometer VT 550 from Haake GmbH, Karlsruhe, DE, MV-DIN cup for viscosity<10 000 mPa·s/23° C., SV-DIN cup for viscosity>10 000 mPa·s/23° C.
NCO content: Back-titration with 1 mol/l HCl following reaction with excess dibutylamine in acetone, based on DIN EN ISO 11909

All percentages below are by weight unless otherwise noted.

### Preparation of Inventive Prepolymers (Examples 1-6)

General Working Procedure:

A solution of a styrene-allyl alcohol copolymer (SAA) in methoxypropyl acetate (MPA) was added dropwise at 90° C. over 3 hours to 1000 g of a 1:1 mixture of 2,4′- and 4,4′-MDI and the mixture was stirred until a constant NCO value was reached.

The SAAs Used Were

SAA-100® from Lyondell AG, US, having an OH content of 6.4% by weight and a molar mass Mₙ of 1400 g/mol and M_{w} of 3100 g/mol and

SAA-101® from Lyondell AG, US, having an OH content of 7.7% by weight and a molar mass Mₙ of 1200 g/mol and M_{w} of 2600 g/mol.

| | SAA-101 | SAA-100 | MPA | Viscosity | NCO content |
|---|---|---|---|---|---|
| Example | [g] | [g] | [g] | [mPas] | [%] |
| 1 | 250 | | 350 | 430 | 18.3 |
| 2 | 300 | | 420 | 1060 | 15.3 |
| 3 | 350 | | 490 | 3750 | 13.5 |
| 4 | | 250 | 350 | 280 | 17.5 |
| 5 | | 300 | 420 | 817 | 15.7 |
| 6 | | 350 | 490 | 2180 | 13.9 |

### Coating Formulation (Examples 7-12 Comparative Example)

General Working Instructions:

The mixture below was used as binder:

| | |
|---|---|
| Prepolymer prepared according to one of Examples 1-6 | 155.4 g |
| Desmodur ® E14 (TDI polypropylene oxide prepolymer | 54.4 g |
| having an NCO content of 3.3% [Bayer MaterialScience AG, | |
| Leverkusen, DE]) for elasticization | |
| Bayferrox ® 130 BM (iron oxide pigment from Lanxess, | 44.5 g |
| Leverkusen, DE) | |
| Heucophos CHP ® (calcium hydrogen orthophosphate, | 58.9 g |
| active rust prevention pigment, from Heubach AG, | |
| Langelsheim, DE) | |
| Talc ST 30 ® (filler from Luzenac AG, Paris, FR) | 64.3 g |
| Disperbyk ® 180 (dispersing additive from Byk Chemie AG, | 3.5 g |
| Wesel, DE) | |
| Byk ® A 530 (deaerating agent from Byk Chemie AG, | 1.6 g |
| Wesel, DE) | |
| Additive TI ® (dryer, tosyl isocyanate, from Borchers AG, | 27.2 g |
| Langenfeld, DE) | |
| Additive OF ® (dryer, tosyl triethyl orthoformate, from | 13.0 g |
| Borchers AG, Langenfeld, DE) | |

0.2 g of Metatin (dibutyltin acetylacetonate) [Acima Buchs, Switzerland] was added to the overall formula, which was then applied by brush in an approximate film thickness of 80 μm to an ST2-pretreated steel panel. The coatings were cured at room temperature for one day (ST2-pretreated: cleaned by using a wire brush, in accordance with ISO 12944-4).

Testing was carried out by means of a salt spray test (scoring and weathering) in accordance with SA DIN 53167. The test was ended when sub-film corrosion at the crack and/or severe rust perforation was observed.

| | | Time to |
|---|---|---|
| | | end of test |
| Example | Prepolymer | [weeks] |
| 7 | 1 | 5 |
| 8 | 2 | 6 |
| 9 | 3 | 8 |
| 10 | 4 | 5 |
| 11 | 5 | 8 |
| 12 | 6 | 5 |
| Comparative | Commercial prepolymer for moisture- | 2 |
| | curing PU coating materials: Desmodur ® E23 | |
| | (MDI on polypropylene oxides, | |
| | from Bayer MaterialScience AG) | |

The prepolymers of the invention produce much more effective corrosion control the prepolymers in accordance with the abovementioned prior art that have been employed hitherto for this purpose.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A method of preparing polyurethane prepolymers comprising reacting
a) one or more OH-functional copolymers of vinylaromatics and allyl alcohol; and
b) methylenediphenyl diisocyanate;
wherein the equivalent ratio of OH to NCO groups is 1:≧2.

2. A method according to claim 1, wherein the reacting of components a) and b) comprises
(i) preparing a solution of component a) in 0.3 to 3 times the amount, by weight based on the copolymer, of a non-isocyanate-reactive solvent,
(ii) metering the solution into component b) in an equivalent ratio of OH groups to NCO groups of 1:2 to 1:20, over a period of 0.5 to 8.0 hours.

3. A method according to claim 1, wherein the vinylaromatics are selected from the group consisting of styrene, 3-methylstyrene, 4-methylstyrene, alpha-methylstyrene, 4-tert-butylstyrene, 4-chlorostyrene, 3-chlorostyrene, 4-bromostyrene, 3-bromostyrene, 2-trifluoromethylstyrene, 3-trifluoromethylstyrene, 4-trifluoromethylstyrene, 4-cyanostyrene, alkyl esters of 4-vinylbenzoic acid and mixtures thereof.

4. Prepolymers obtainable by the process according to any one of claims 1.

5. Moisture-curing coating materials comprising prepolymers according to claim 4.

6. Moisture-curing coating materials according to claim 5, further comprising pigments, active rust prevention pigments, corrosion inhibitors, fillers, dryers, catalysts and/or mixtures thereof.

7. Moisture-curing coating materials according to claim 5, further comprising additional polyisocyanates or isocyanate-functional prepolymers as binders.

8. Moisture-curing coating materials according to claim 6, characterized in that the dryer is based on tosyl isocyanate, reactive aromatic isocyanates, orthoformates and/or mixtures thereof.

9. A method of producing a coating comprising:
A) reacting:
a) one or more OH-functional copolymers of vinylaromatics and allyl alcohol; and
b) methylenediphenyl diisocyanate;
wherein the equivalent ratio of OH to NCO groups is 1:≧2 to form a moisture-curing coating material;
B) applying the moisture-curing coating material to a substrate; and
C) curing the coating at a temperature of 0 to 80° C.

10. Products produced by the method of claim 9.
